(19) United States
(12) Patent Application Publication
(10) Pub. No.: US 2023/0245247 A1
(43) Pub. Date: Aug. 3, 2023

(54) Online Platform for Digital Content via Blockchain

(71) Applicant: Meta Platforms, Inc., Menlo Park, CA (US)

(72) Inventor: Hongzheng Xiong, Mountain View, CA (US)

(21) Appl. No.: 16/115,487

(22) Filed: Aug. 28, 2018

(51) Int. Cl. G06Q 50/00; G06Q 30/02; G06Q 20/36; G06Q 20/06

(52) U.S. Cl. CPC G06Q 50/01; G06Q 30/0269; G06Q 20/3678; G06Q 20/065; G06Q 2220/00

(57) ABSTRACT

In one embodiment, a method includes receiving information associated with a project for creation of digital content and generating an object including the received information, where the object is stored by a social-networking system. The method also includes causing a data item associated with a blockchain network to be generated and deployed to the blockchain network, where the data item is generated based on the information associated with the project that is included in the object, is associated with a type of token recorded in a blockchain associated with the blockchain network, and includes instructions executable according to a protocol associated with the blockchain network. The method further includes collecting information associated with the data item from the blockchain and updating the object based on the collected information.

### TECHNICAL FIELD

This disclosure generally relates to an online platform for digital content.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, a social-networking system may host an online platform for publishing of, investment in and consumption of digital content. The online platform may serve as a digital content marketplace for funding of content-production companies and exchange of stake in digital content. The online platform hosted by the social-networking system may allow content producers to conveniently set up arrangements for investing in their business and connect the producers to the public. In particular embodiments, the social-networking system may also provide an online platform for listing digital content for purchase and consumption, for displaying information about the digital content (e.g., historical transaction information, profit information, stock price information) and producers of the digital content, for communication among participants or investors of a project related to digital content, and for advertising and marketing related to the digital content. The social-networking system may provide tools and interfaces related to investment and payment in connection with a blockchain. The platform may provide an interface to one or more blockchain networks. Functionalities such as cryptocurrency token sales, token-based voting, dividend distribution, or record keeping may be achieved through this interface. Particular embodiments bring about technical improvement over existing technology by aggregating, organizing, and using, in a novel manner, data and resources available from one or more blockchain networks, one or more client systems associated with users, one or more systems associated with digital-content-production companies, or one or more third-party systems. Particular embodiments improve upon existing technology by intelligently automating the process for creating algorithmic investment plans using blockchain technology and the process for investing in and purchasing digital content and integrating such processes with the distribution of information about the digital content, which may improve the accuracy and efficiency of the processes.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example network environment associated with an online platform for investment in and consumption of digital content.

FIG. 1B illustrates an example ecosystem for funding and marketing digital content.

FIG. 2A illustrates an example method for managing investment in a project based on a blockchain.

FIG. 2B illustrates an example method for marketing and managing payments for digital content.

FIG. 3 illustrates an example network environment associated with a social-networking system.

FIG. 4 illustrates an example social graph.

FIGS. 5A and 5B illustrate an example method for recording a transaction in a blockchain.

FIG. 6 illustrates an example computer system.

### DESCRIPTION OF EXAMPLE EMBODIMENTS

In particular embodiments, a social-networking system may host an online platform for publishing of, investment in and consumption of digital content. The online platform may serve as a digital content marketplace for funding of content-production companies and exchange of stake in digital content. Digital content (like movie, software, digital service, etc.) producers often have a hard time to raise funding—arranging equity and debt for a content-production company is not only complicated but also expensive. Setting up an initial public offering to allow the public to invest in a project and enjoy the financial returns is often only possible for a very limited number of successful companies. At the same time, people around the world also cannot easily invest in the contents they are interested in, or support their favorite singers, musicians, movies, movie stars and invest in their success. The online platform hosted by the social-networking system may allow content producers to conveniently set up arrangements for investing in their business and connect the producers to the public. In particular embodiments, the social-networking system may also provide an online platform for listing digital content for purchase and consumption, for displaying information about the digital content (e.g., historical transaction information, profit information, stock price information) and producers of the digital content, for communication among participants or investors of a project related to digital content, and for advertising and marketing related to the digital content. The social-networking system may provide tools and interfaces related to investment and payment in connection with a blockchain. The platform may provide an interface to one or more blockchain networks. Functionalities such as cryptocurrency token sales, token-based voting, dividend distribution, or record keeping may be achieved through this interface. Particular embodiments bring about technical improvement over existing technology by aggregating, organizing, and using, in a novel manner, data and resources available from one or more blockchain networks, one or more client systems associated with users, one or more systems associated with digital-content production companies, or one or more third-party systems. Particular embodiments improve upon existing technology by intelligently automating the process for creating algorithmic investment plans using blockchain technology and the process for investing in and purchasing digital content and integrating such processes with the distribution of information about the digital content, which may improve the accessibility and efficiency of the processes.

In particular embodiments, the online platform may comprise a plurality of objects, each corresponding to an entity (e.g., a virtual company) for producing digital content. The online platform may also comprise a plurality of objects each corresponding to an existing or potential digital content item. In particular embodiments, a producer of a digital content may issue “digital shares” or other suitable tokens to represent equity or ownership of a business entity associated with the producer or existing or potential digital content produced by the producer. The tokens may be used to raise funds for content production. In particular embodiments, a producer may publish information on the social-networking system (e.g., in a profile page) about an ownership structure for particular business entities or digital content (e.g., initial price per share, voting power associated with each share, initial capital of a business entity). In particular embodiments, digital content may be offered for purchase or consumption on the online platform. The producer of the content may derive revenue from sales proceeds or advertisement income from the content. In particular embodiments, the platform may also provide marketing functionalities. For example, the platform may distribute advertisements for purchasing digital content or investing in the same.

In particular embodiments, the online platform may comprise an interface to a public blockchain. The social-networking system may interface with the public blockchain directly or through a third-party provider of services related to blockchain. The platform associated with the social-networking system may comprise one or more users interfaces allowing a producer of digital content to start an initial coin offering or other types of suitable token offerings on the public blockchain. One or more computing systems associated with the platform may also scan the public blockchain on a regular basis and display information obtained from the blockchain (e.g., token ownership statistics). The platform may allow a user to link her account with the social-networking system to a blockchain account (or wallet) and may provide the functionality of exchanging between cryptocurrencies and fiat currencies. In particular embodiments, the platform may also comprise functionalities such as initiating a token-based voting on the public blockchain. The voting may allow stakeholders in a business entity for producing digital content make decisions about the business entity according to a certain rule (e.g., majority rule). The decisions may be related to, for example, use of the business entity's income (e.g., marketing, paying dividends, producing new content) or content creation (e.g., actor selection). Voting may be held periodically. The voting may alternatively be fully or partially performed on the social-networking system or one or more suitable third-party systems.

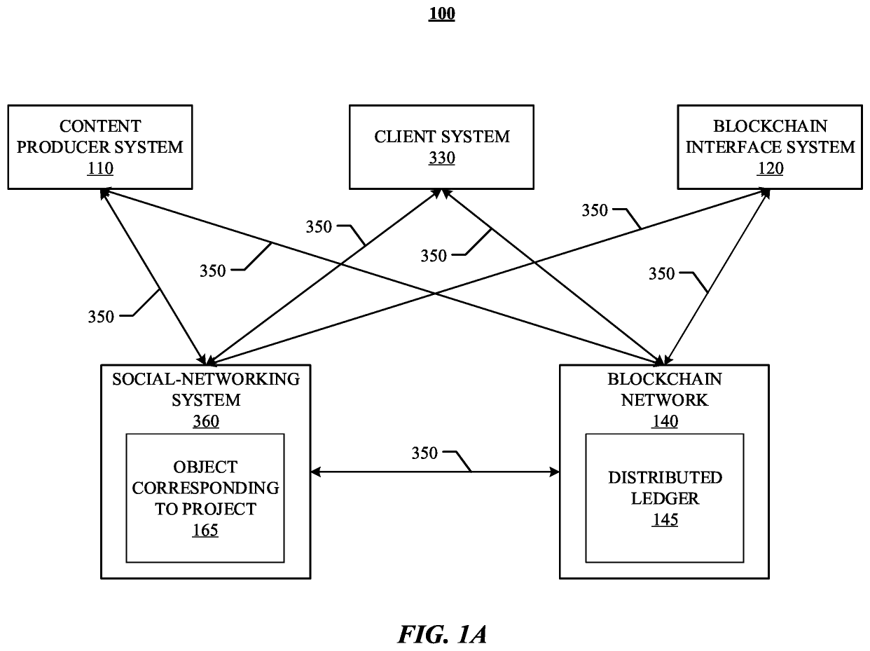

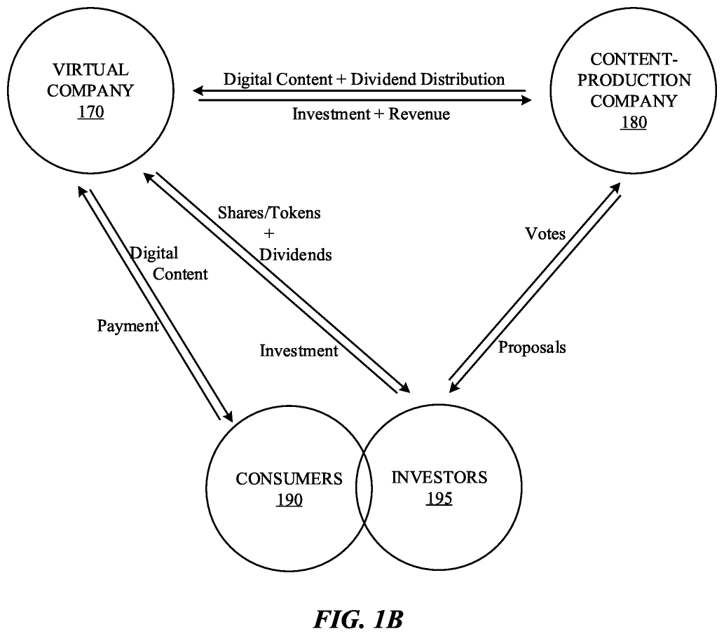

FIG. 1A illustrates an example network environment 100 associated with an online platform for investment in and consumption of digital content. In particular embodiments, the network environment 100 may comprise a social-networking system 360. The social-networking system 360 may host an online platform for investment in and consumption of digital content. The social-networking system 360 may comprise one or more objects 165 each corresponding to a project for producing digital content. An object 165 may be associated with, for example, an individual or business entity engaged in producing digital content, an existing or potential digital content, or a plan to produce one or more digital content products. The object 165 may be named a “virtual company,” which corresponds to the real-world business entity that produces the digital content. In particular embodiments, the network environment 100 may comprise a blockchain network 140. The blockchain network 140 may comprise a plurality of nodes, each of which may comprise a computing system embodying software in compliance with a protocol associated with a blockchain and storing a distributed ledger 145 recording a plurality of transactions associated with the blockchain. The blockchain associated with the blockchain network 140 may support one or more cryptocurrencies. In particular embodiments, the network environment 100 may comprise one or more content producer systems 110. A content producer system 110 may comprise one or more computing devices associated with a content-production company, a business entity for producing digital content (e.g., music, movies, TV shows, software package, mobile applications). In particular embodiments, the network environment 100 may comprise one or more client systems 330 associated with one or more users of the social-networking system 360. In particular embodiments, the network environment 120 may comprise a blockchain interface system 120. The blockchain interface system 120 may provide one or more services associated with the blockchain network 140 (e.g., creating transactions, generating smart contracts or distributed applications, scanning distributed ledgers, creating a voting event). In particular embodiments, the aforementioned systems in the network environment 100 may be connected to each other by one or more network connections or links 350.

In particular embodiments, the social-networking system 360 may receive information associated with a project for creation of digital content from a content producer system 110. The social-networking system 360 may generate an object 165 comprising the received information. In particular, the object 165 may comprise information about the digital content associated with the project, information about one or more entities associated with the project, at least a portion of the digital content, information associated with the data item associated with the blockchain network, one or more content items created by one or more users of the social-networking system 360, other suitable information, or any combination thereof. The object 165 may be stored in one or more data stores associated with the social-networking system 360. One or more user interfaces sent by the social-networking system 360 to one or more client systems 330 associated with one or more users may display at least part of the information stored in the object 165. As an example and not by way of limitation, the social-networking system 360 may send for display a user interface associated with a project to produce a movie. The user interface may be a profile page associated with the movie or a producer of the movie, a page associated with an on-demand streaming service of the social-networking system 360, another suitable user interface, or any combination thereof. The user interface may comprise, for example, a description of the movie, a description of the producer of the movie, a trailer, a description of a token issuing event for investing in the producer or the movie (e.g., ownership interest, voting power, profit sharing rights, instructions for investing), a link to a user interface showing the movie, a link to reviews on the movie, marketing materials for the movie, other suitable content associated with the project, or any combination thereof.

In particular embodiments, the social-networking system 360 may cause a data item associated with a blockchain network 140 to be generated and deployed to the blockchain network 140. The data item may be generated based on the information associated with the project that is comprised by the object 165. The data item may be associated with a type of token recorded in a blockchain associated with the blockchain network 140. The data item may comprise instructions executable according to a protocol associated with the blockchain network. As an example and not by way of limitation, the data item may comprise a smart contract that may be stored in a block in the blockchain and distributed among each node of the blockchain network 140. The smart contract may be programmed to perform particular actions on the blockchain based on receipt of particular transactions and satisfaction of pre-determined conditions or states. The smart contract may comprise one or more functionalities including, for example, receiving and processing a payment, issuing and distributing tokens transferable by transactions on the blockchain, receiving votes signed by private keys associated, other suitable functionalities, or any combination thereof. In particular embodiments, the social-networking system 360 may generate the data item and deploy the data item to the blockchain network 140 in response to particular input received from the content producer system 110. As an example and not by way of limitation, the social-networking system 360 may send to a producer of digital content a user interface for display. The user interface may allow the producer to set up a blockchain token sale event for investment in a music album to be produced. The producer may specify various parameters of the token sale event such as a number of tokens to be issued, a currency acceptable for purchasing the tokens, a price of the tokens sold, other suitable parameters, or any combination thereof. In response to the inputs by the producer, the social-networking system 360 may generate the data item configured to perform the functionalities specified by the producer.

In particular embodiments, the social-networking system 360 may deploy the data item to the blockchain network 140 by broadcasting the data item to one or more nodes of the blockchain network 140. One or more of the nodes may authenticate the data item, forward the data item to one or more other nodes, packaging the data item and one or more other data items into a new block, or broadcast the new block to one or more other nodes. The social-networking system 360 may or may not act as a node of the blockchain network 140. All the nodes of the blockchain network 140 may reach a consensus on a new version of the blockchain incorporating the data item. In particular embodiments, rather than directly generating and deploying the data item, the social-networking system 360 may send instructions associated with the data item to a third-party system interfacing with the blockchain network. The third-party system may be the blockchain interface system 120 as shown in FIG. 1A. The instructions may specify one or more parameters of the data item sufficient for the blockchain interface system 120 to generate and deploy the data item.

As illustrated by the examples above, the data item may be executable to cause a sale of the tokens on the blockchain network 140. The data item may also be executable to implement one or more different functionalities, such as voting based on ownership of tokens, distribution of dividends based on ownership of tokens, exchange between tokens associated with the data item and one or more other cryptocurrencies, another suitable functionality, or any combination thereof. In particular embodiments, the online platform hosted by the social-networking system may comprise the module for exchanging between the tokens associated with the data item and a fiat currency (e.g., US dollars). As an example and not by way of limitation, the social-networking system may receive, at a first cryptocurrency wallet associated with the social-networking system and compatible with the protocol associated with the blockchain network, a number of tokens of the type associated with the data item. The tokens may be received from a second cryptocurrency wallet associated with a user. The social-networking system may then send, to a fiat currency account associated with the user, an amount of fiat currency, wherein the amount of fiat currency is determined based on a value of the number of tokens. As another example and not by way of limitation, the social-networking system 360 may receive a request from a user to purchase tokens associated with the data item and a payment in a fiat currency from an account associated with the user to an account associated with the social-networking system 360. The social-networking system 360 may cause a transaction to be generated and deployed to the blockchain network 140. The transaction may call or reference the data item and cause the data item to issue or transfer additional tokens to a cryptocurrency wallet associated with the user.

In particular embodiments, the social-networking system 360 may collect information associated with the data item from the blockchain and update the object associated with the project based on the collected information. In particular embodiments, the blockchain stored by the blockchain network 140 may be completely or partially accessible to the public. Particular information in the blockchain (e.g., transactions) may be made accessible to relevant parties or systems holding requisite cryptographic keys. The social-networking system 360 may access information stored as part of the blockchain directly or through the blockchain interface system 120. The information accessed may correspond to a plurality of transactions calling or referencing the data item. The social-networking system 360 may aggregate, analyze, and organize the information gathered and update object accordingly. For example, the social-networking system 360 may add to the object a percentage of tokens issued sold, a number of holders of tokens associated with the project, a number or amount of payments made to the producer in cryptocurrency, an average price of the tokens associated with the data item in another cryptocurrency, other suitable information, or any combination thereof. The updated information may be provided for display in one or more user interfaces of the online platform hosted by the social-networking system 360 (e.g., profile page of the producer or content item).

In particular embodiments, the online platform hosted by the social-networking system 360 may have one or more modules for marketing or sales of digital content. In particular embodiments, a producer of digital content may upload the digital content to the social-networking system 360. The social-networking system may provide the digital content to one or more client systems associated with its users for watching, reading, or listening. The digital content may be streamed or downloaded. In particular embodiments, the social-networking system 360 may send, to one or more client devices respectively associated with one or more users, an advertisement associated with the digital content. The advertisement may be related to consuming the content or investing in the creation of the content. The advertisement may comprise, for example, a link to a user interface streaming the digital content or a user interface associated with crowdfunding for related project. In particular embodiments, the social-networking system 360 may process a payment for consumption of the digital content. It may receive, from a client device associated with a user, credentials associated with a payment for consuming the digital content and cause the payment to be collected based on the received credentials.

FIG. 1B illustrates an example ecosystem for funding and marketing digital content. In particular embodiments, a virtual company 170 associated with a project for creation of digital content may be created on the social-networking system 360. The virtual company 170 may be created by a content-production company 180 that initiates the project, one or more consumers 190 who may be users of the social-networking system 360, and one or more investors 195 who may also be users of the social-networking system 360. Some users may both invest in a project for creating digital content and consume the digital content created. In particular embodiments, the virtual company 170 may display information about the content-production project to one or more users. The information displayed may be provided by the content-production company 180 or be collected from third-party sources by the social-networking system 360.

In particular embodiments, the project for creating the digital content may initially be funded by one or more founders, employees, or early-stage investors to the content-production company 180. The content-production company 180 may solicit additional investment through the virtual company 170. The investors 195 may send investments (in fiat currency or cryptocurrency) to one or more accounts associated with the virtual company 170. In exchange, the virtual company 170 may cause share certifications or blockchain tokens to be sent to the investors. The investment from the investors 195 may be forwarded by the virtual company 170 to the content-production company 180 to fund the production of the digital content.

In particular embodiments, after the digital content is created, the content production company 180 may send the digital content to the social-networking system 360 for publication in a user interface associated with the virtual company 170. The digital content may be made available to one or more consumers 190 for purchase. The consumers 190 may send payments to one or more accounts associated with the virtual company 170 in order to watch, listen to, or otherwise consume the digital content. The revenue collected by the virtual company 170 may be forward to the content-production company 180.

In particular embodiments, the content-production company 180 may make dividend distributions using profit it derives from the digital content. It may send the fund for dividend distributions to the virtual company 170. The virtual company 170 may then cause the dividends to be distributed to the investors 195 based on their respective equity holdings in the content-production company 180.

In particular embodiments, the content-production company 180 may adopt a collective decision-making process involving the investors 195. It may send one or more proposals to the investors 195 for voting. The proposals may comprise, for example, a spending plan to run advertisements, a plan to pay dividends, a plan to buy back stocks, another suitable proposal, or any combination thereof. The content-production company 180 may initiate a voting event for each of the proposals. The voting event may be hosted through the virtual company 170, through one or more smart contracts on the blockchain network 140, or through direct communication with the investors 195. The investors 195 may send votes back to the content-production company 180 using an appropriate method.

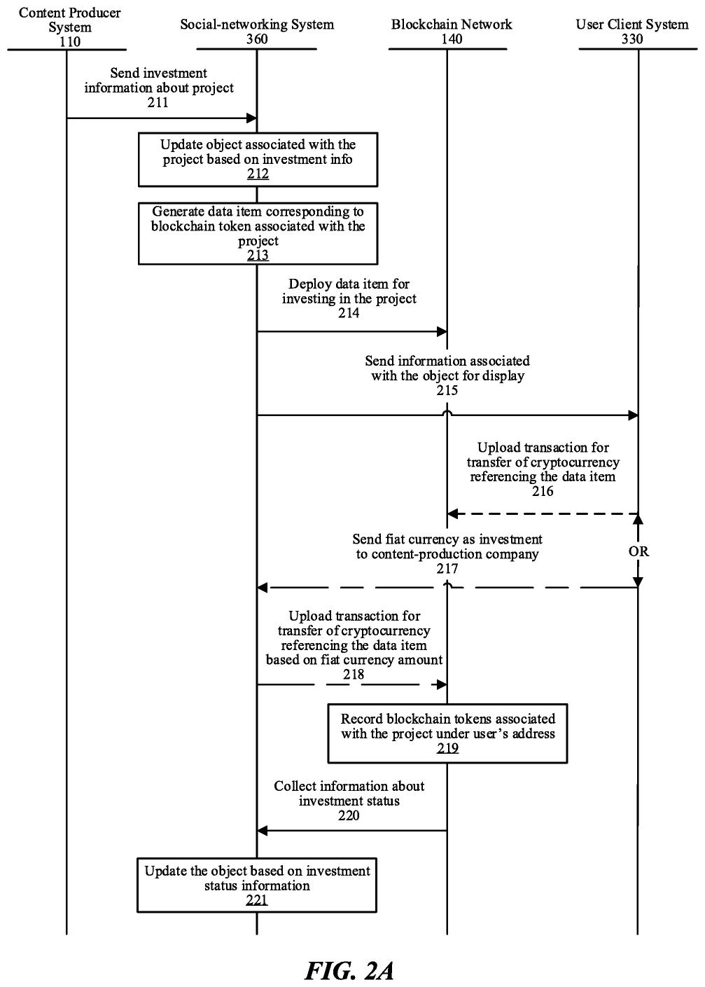

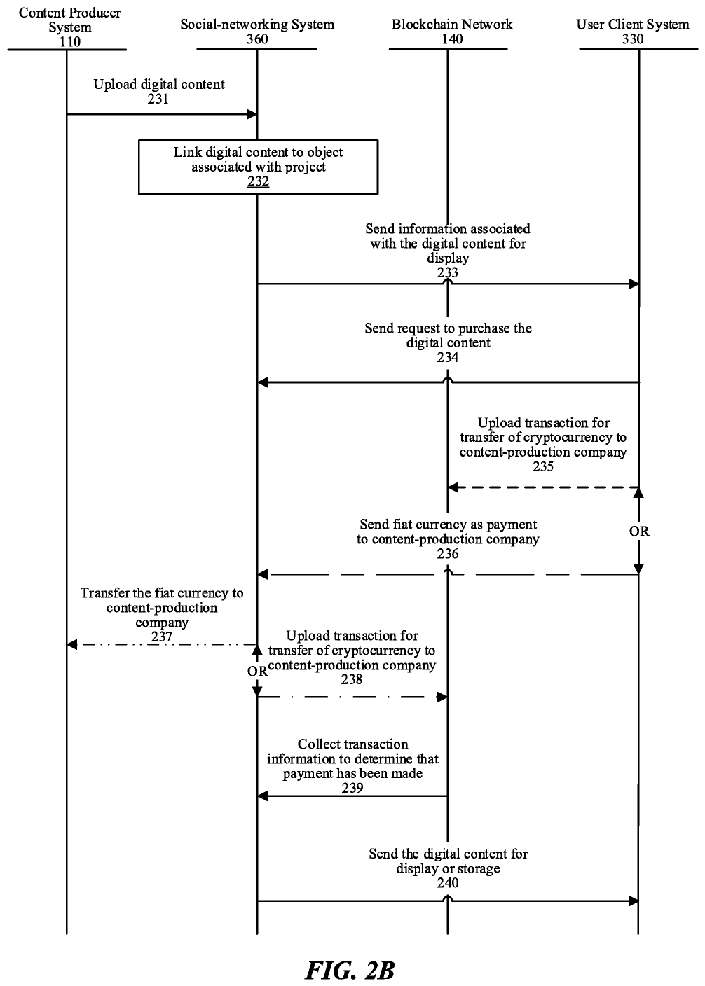

FIG. 2A illustrates an example method for managing investment in a project based on a blockchain. The method may begin at step 211, where a content producer system 110 may send investment information about a project to a social-networking system 360. The investment information may comprise, for example, a number of tokens to be issued, a currency acceptable for purchasing the tokens, a price of the tokens sold, other suitable parameters, or any combination thereof. At step 212, the social-networking system 360 may update an object associated with the project based on the investment information. Information contained in the object may be provided for display one or more user client systems 330. It may inform the users as to the opportunity to invest in the project. At step 213, the social-networking system 360 may generate a data item (e.g., a smart contract, a distributed application) corresponding to a type of blockchain token associated with the project. The data item may be executed by the blockchain network 140 to perform one or more functionality related to investing in the project. At step 214, the social-networking system 360 may deploy the data item to the blockchain network 140 by directly sending the data item to one or more nodes of the blockchain network 140 or sending suitable instructions to a blockchain interface system 120. At step 215, the social-networking system 360 may send information associated with the object for display on one or more user client systems 330. The information may comprise instructions as to how to invest in the project. One or more users may become interested in investing in the project. The users may invest in the project by purchasing tokens associated with the data item using blockchain transactions. At step 216, the user client system 330 may update a transaction corresponding to a transfer of cryptocurrency acceptable as investment. The cryptocurrency may be transferred to a blockchain address associated with the producer of the digital content. The transaction may call or reference the data item. In response to the transfer of cryptocurrency, at step 219, the blockchain network 140 may execute the data item to record blockchain tokens associated with the project under the user's address. Alternatively, the user may invest in the project through the social-networking system 360. At step 217, the user may send an amount of fiat currency from user client system 330 to an account managed by the social-networking system 360 along with a request to invest in the project. At step 218, the social-networking system 360 may upload a transaction for transfer of an amount of cryptocurrency to the blockchain network 140. The transaction may call or reference the data item. The amount of cryptocurrency may be based on a conversation rate between the cryptocurrency and the fiat currency paid by the user. The transaction may also indicate an address of the user. Similarly, in response, the blockchain network 140 may execute the data item to record blockchain tokens associated with the project under the user's address at step 219. At step 220, the social-networking system 360 may collect information about the status of the investment (e.g., percentage completed with respect to financing goal). At step 221, the social-networking system 360 may update the object corresponding to the project based on the collected investment status. Some of the updated information may be provided for display to one or more users.

Particular embodiments may repeat one or more steps of the method of FIG. 2A, where appropriate. Although this disclosure describes and illustrates particular steps of the method of FIG. 2A as occurring in a particular order, this disclosure contemplates any suitable steps of the method of FIG. 2A occurring in any suitable order. Moreover, although this disclosure describes and illustrates an example method for managing investment in a project based on a blockchain including the particular steps of the method of FIG. 2A, this disclosure contemplates any suitable method for managing investment in a project based on a blockchain including any suitable steps, which may include all, some, or none of the steps of the method of FIG. 2A, where appropriate. Furthermore, although this disclosure describes and illustrates particular components, devices, or systems carrying out particular steps of the method of FIG. 2A, this disclosure contemplates any suitable combination of any suitable components, devices, or systems carrying out any suitable steps of the method of FIG. 2A.

FIG. 2B illustrates an example method for marketing and managing payments for digital content. The method may begin at step 231, where a content producer system 110 uploads a digital content item to the social-networking system 360. The digital content item may comprise, for example, a video file, an audio file, a text file, another suitable file, or any combination thereof. At step 232, the social-networking system 360 may link the digital content received to an object associated with the project of the producer. At step 233, the social-networking system 360 may send information associated with the digital content to one or more user client systems 330 for display. The information may comprise, for example, an advertisement about the digital content. One or more users receiving the information may become interested in the digital content. At step 234, such a user may send, using a user client system 330, a request to purchase the digital content to the social-networking system 360. The user may pay for the digital content in different ways. For example, the user may directly pay for the digital content through a blockchain transaction. At step 235, the user may upload a transaction to the blockchain network 140, where the transaction is for transfer of cryptocurrency to a cryptocurrency wallet associated with the producer. Alternatively, the user may pay for the digital content through the social-networking system. At step 236, the user may send the social-networking system 360 an amount of fiat currency as payment to the content-production company. The social-networking system may transfer the payment to the content-production company in fiat currency or cryptocurrency. For example, at step 237, the social-networking system 360 may directly transfer the received fiat currency to an account associated with the content-production company. Alternatively, at step 238, the social-networking system 360 may upload a transaction to the blockchain network 140 a transaction for transfer of cryptocurrency to a cryptocurrency wallet associated with the content-production company. At step 239, the social-networking system 360 may collect transaction information from the blockchain to determine that the user has made a required payment to the content-production company. If so, at step 240, the social-networking system may send the digital content for display or storage at the user client system 330 or otherwise give the user access to the digital content.

Particular embodiments may repeat one or more steps of the method of FIG. 2B, where appropriate. Although this disclosure describes and illustrates particular steps of the method of FIG. 2B as occurring in a particular order, this disclosure contemplates any suitable steps of the method of FIG. 2B occurring in any suitable order. Moreover, although this disclosure describes and illustrates an example method for marketing and managing payments for digital content including the particular steps of the method of FIG. 2B, this disclosure contemplates any suitable method for marketing and managing payments for digital content including any suitable steps, which may include all, some, or none of the steps of the method of FIG. 2B, where appropriate. Furthermore, although this disclosure describes and illustrates particular components, devices, or systems carrying out particular steps of the method of FIG. 2B, this disclosure contemplates any suitable combination of any suitable components, devices, or systems carrying out any suitable steps of the method of FIG. 2B.

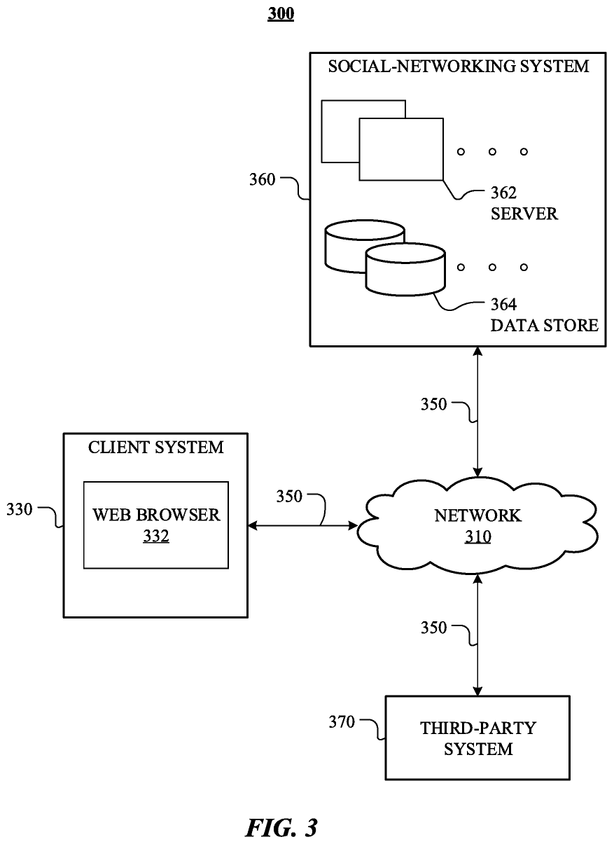

FIG. 3 illustrates an example network environment 300 associated with a social-networking system. Network environment 300 includes a client system 330, a social-networking system 360, and a third-party system 370 connected to each other by a network 310. Although FIG. 3 illustrates a particular arrangement of client system 330, social-networking system 360, third-party system 370, and network 310, this disclosure contemplates any suitable arrangement of client system 330, social-networking system 360, third-party system 370, and network 310. As an example and not by way of limitation, two or more of client system 330, social-networking system 360, and third-party system 370 may be connected to each other directly, bypassing network 310. As another example, two or more of client system 330, social-networking system 360, and third-party system 370 may be physically or logically co-located with each other in whole or in part. Moreover, although FIG. 3 illustrates a particular number of client systems 330, social-networking systems 360, third-party systems 370, and networks 310, this disclosure contemplates any suitable number of client systems 330, social-networking systems 360, third-party systems 370, and networks 310. As an example and not by way of limitation, network environment 300 may include multiple client system 330, social-networking systems 360, third-party systems 370, and networks 310.

This disclosure contemplates any suitable network 310. As an example and not by way of limitation, one or more portions of network 310 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 310 may include one or more networks 310.

Links 350 may connect client system 330, social-networking system 360, and third-party system 370 to communication network 310 or to each other. This disclosure contemplates any suitable links 350. In particular embodiments, one or more links 350 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 350 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 350, or a combination of two or more such links 350. Links 350 need not necessarily be the same throughout network environment 300. One or more first links 350 may differ in one or more respects from one or more second links 350.

In particular embodiments, client system 330 may be an electronic device including hardware, software, or embedded logic components or a combination of two or more such components and capable of carrying out the appropriate functionalities implemented or supported by client system 330. As an example and not by way of limitation, a client system 330 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 330. A client system 330 may enable a network user at client system 330 to access network 310. A client system 330 may enable its user to communicate with other users at other client systems 330.

In particular embodiments, client system 330 may include a web browser 332, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 330 may enter a Uniform Resource Locator (URL) or other address directing the web browser 332 to a particular server (such as server 362, or a server associated with a third-party system 370), and the web browser 332 may generate a Hyper Text Transfer Protocol (HTTP) request and communicate the HTTP request to server. The server may accept the HTTP request and communicate to client system 330 one or more Hyper Text Markup Language (HTML) files responsive to the HTTP request. Client system 330 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 360 may be a network-addressable computing system that can host an online social network. Social-networking system 360 may generate, store, receive, and send social-networking data, such as, for example, user-profile data, concept-profile data, social-graph information, or other suitable data related to the online social network. Social-networking system 360 may be accessed by the other components of network environment 300 either directly or via network 310. As an example and not by way of limitation, client system 330 may access social-networking system 360 using a web browser 332, or a native application associated with social-networking system 360 (e.g., a mobile social-networking application, a messaging application, another suitable application, or any combination thereof) either directly or via network 310. In particular embodiments, social-networking system 360 may include one or more servers 362. Each server 362 may be a unitary server or a distributed server spanning multiple computers or multiple datacenters. Servers 362 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 362 may include hardware, software, or embedded logic components or a combination of two or more such components for carrying out the appropriate functionalities implemented or supported by server 362. In particular embodiments, social-networking system 360 may include one or more data stores 364. Data stores 364 may be used to store various types of information. In particular embodiments, the information stored in data stores 364 may be organized according to specific data structures. In particular embodiments, each data store 364 may be a relational, columnar, correlation, or other suitable database. Although this disclosure describes or illustrates particular types of databases, this disclosure contemplates any suitable types of databases. Particular embodiments may provide interfaces that enable a client system 330, a social-networking system 360, or a third-party system 370 to manage, retrieve, modify, add, or delete, the information stored in data store 364.

In particular embodiments, social-networking system 360 may store one or more social graphs in one or more data stores 364. In particular embodiments, a social graph may include multiple nodes—which may include multiple user nodes (each corresponding to a particular user) or multiple concept nodes (each corresponding to a particular concept)—and multiple edges connecting the nodes. Social-networking system 360 may provide users of the online social network the ability to communicate and interact with other users. In particular embodiments, users may join the online social network via social-networking system 360 and then add connections (e.g., relationships) to a number of other users of social-networking system 360 to whom they want to be connected. Herein, the term “friend” may refer to any other user of social-networking system 360 with whom a user has formed a connection, association, or relationship via social-networking system 360.

In particular embodiments, social-networking system 360 may provide users with the ability to take actions on various types of items or objects, supported by social-networking system 360. As an example and not by way of limitation, the items and objects may include groups or social networks to which users of social-networking system 360 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 360 or by an external system of third-party system 370, which is separate from social-networking system 360 and coupled to social-networking system 360 via a network 310.

In particular embodiments, social-networking system 360 may be capable of linking a variety of entities. As an example and not by way of limitation, social-networking system 360 may enable users to interact with each other as well as receive content from third-party systems 370 or other entities, or to allow users to interact with these entities through an application programming interfaces (API) or other communication channels.

In particular embodiments, a third-party system 370 may include one or more types of servers, one or more data stores, one or more interfaces, including but not limited to APIs, one or more web services, one or more content sources, one or more networks, or any other suitable components, e.g., that servers may communicate with. A third-party system 370 may be operated by a different entity from an entity operating social-networking system 360. In particular embodiments, however, social-networking system 360 and third-party systems 370 may operate in conjunction with each other to provide social-networking services to users of social-networking system 360 or third-party systems 370. In this sense, social-networking system 360 may provide a platform, or backbone, which other systems, such as third-party systems 370, may use to provide social-networking services and functionality to users across the Internet.

In particular embodiments, a third-party system 370 may include a third-party content object provider. A third-party content object provider may include one or more sources of content objects, which may be communicated to a client system 330. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 360 also includes user-generated content objects, which may enhance a user's interactions with social-networking system 360. User-generated content may include anything a user can add, upload, send, or “post” to social-networking system 360. As an example and not by way of limitation, a user communicates posts to social-networking system 360 from a client system 330. Posts may include data such as status updates or other textual data, location information, photos, videos, links, music or other similar data or media. Content may also be added to social-networking system 360 by a third-party through a “communication channel,” such as a newsfeed or stream.

In particular embodiments, social-networking system 360 may include a variety of servers, sub-systems, programs, modules, logs, and data stores. In particular embodiments, social-networking system 360 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 360 may also include suitable components such as network interfaces, security mechanisms, load balancers, failover servers, management-and-network-operations consoles, other suitable components, or any suitable combination thereof. In particular embodiments, social-networking system 360 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 360 to one or more client systems 330 or one or more third-party system 370 via network 310. The web server may include a mail server or other messaging functionality for receiving and routing messages between social-networking system 360 and one or more client systems 330. An API-request server may allow a third-party system 370 to access information from social-networking system 360 by calling one or more APIs. An action logger may be used to receive communications from a web server about a user's actions on or off social-networking system 360. In conjunction with the action log, a third-party-content-object log may be maintained of user exposures to third-party-content objects. A notification controller may provide information regarding content objects to a client system 330. Information may be pushed to a client system 330 as notifications, or information may be pulled from client system 330 responsive to a request received from client system 330. Authorization servers may be used to enforce one or more privacy settings of the users of social-networking system 360. A privacy setting of a user determines how particular information associated with a user can be shared. The authorization server may allow users to opt in to or opt out of having their actions logged by social-networking system 360 or shared with other systems (e.g., third-party system 370), such as, for example, by setting appropriate privacy settings. Third-party-content-object stores may be used to store content objects received from third parties, such as a third-party system 370. Location stores may be used for storing location information received from client systems 330 associated with users. Advertisement-pricing modules may combine social information, the current time, location information, or other suitable information to provide relevant advertisements, in the form of notifications, to a user.

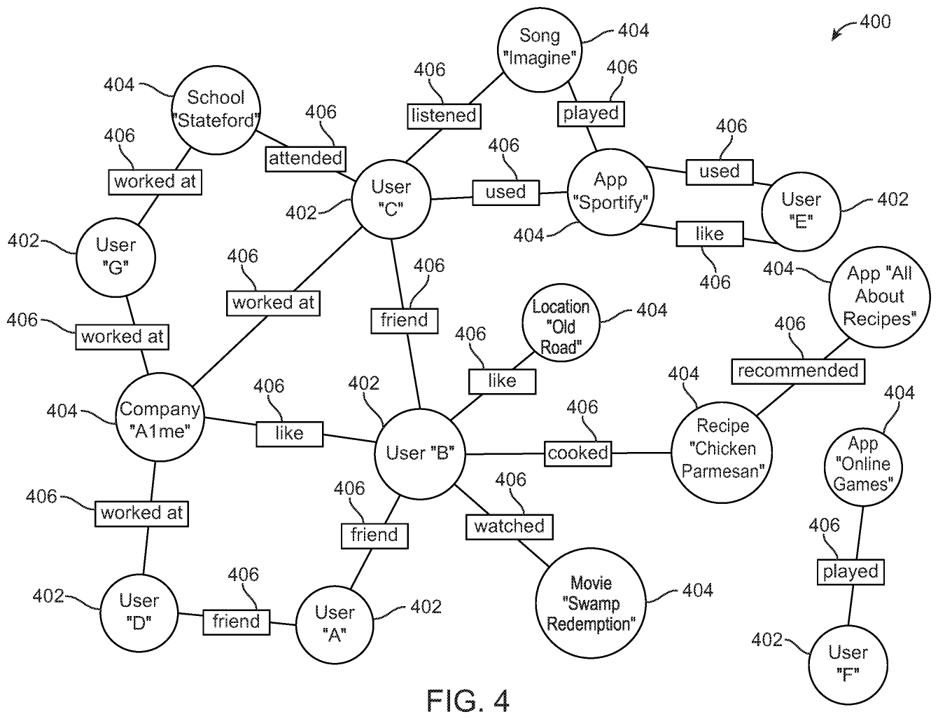

FIG. 4 illustrates example social graph 400. In particular embodiments, social-networking system 360 may store one or more social graphs 400 in one or more data stores. In particular embodiments, social graph 400 may include multiple nodes—which may include multiple user nodes 402 or multiple concept nodes 404—and multiple edges 406 connecting the nodes. Each node may be associated with a unique entity (i.e., user or concept), each of which may have a unique identifier (ID), such as a unique number or username. Example social graph 400 illustrated in FIG. 4 is shown, for didactic purposes, in a two-dimensional visual map representation. In particular embodiments, a social-networking system 360, client system 330, or third-party system 370 may access social graph 400 and related social-graph information for suitable applications. The nodes and edges of social graph 400 may be stored as data objects, for example, in a data store (such as a social-graph database). Such a data store may include one or more searchable or queryable indexes of nodes or edges of social graph 400.

In particular embodiments, a user node 402 may correspond to a user of social-networking system 360. As an example and not by way of limitation, a user may be an individual (human user), an entity (e.g., an enterprise, business, or third-party application), or a group (e.g., of individuals or entities) that interacts or communicates with or over social-networking system 360. In particular embodiments, when a user registers for an account with social-networking system 360, social-networking system 360 may create a user node 402 corresponding to the user, and store the user node 402 in one or more data stores. Users and user nodes 402 described herein may, where appropriate, refer to registered users and user nodes 402 associated with registered users. In addition or as an alternative, users and user nodes 402 described herein may, where appropriate, refer to users that have not registered with social-networking system 360. In particular embodiments, a user node 402 may be associated with information provided by a user or information gathered by various systems, including social-networking system 360. As an example and not by way of limitation, a user may provide his or her name, profile picture, contact information, birth date, sex, marital status, family status, employment, education background, preferences, interests, or other demographic information. In particular embodiments, a user node 402 may be associated with one or more data objects corresponding to information associated with a user. In particular embodiments, a user node 402 may correspond to one or more webpages.

In particular embodiments, a concept node 404 may correspond to a concept. As an example and not by way of limitation, a concept may correspond to a place (such as, for example, a movie theater, restaurant, landmark, or city); a website (such as, for example, a website associated with social-network system 360 or a third-party website associated with a web-application server); an entity (such as, for example, a person, business, group, sports team, or celebrity); a resource (such as, for example, an audio file, video file, digital photo, text file, structured document, or application) which may be located within social-networking system 360 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 404 may be associated with information of a concept provided by a user or information gathered by various systems, including social-networking system 360. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 404 may be associated with one or more data objects corresponding to information associated with concept node 404. In particular embodiments, a concept node 404 may correspond to one or more webpages.

In particular embodiments, a node in social graph 400 may represent or be represented by a webpage (which may be referred to as a “profile page”). Profile pages may be hosted by or accessible to social-networking system 360. Profile pages may also be hosted on third-party websites associated with a third-party system 370. As an example and not by way of limitation, a profile page corresponding to a particular external webpage may be the particular external webpage and the profile page may correspond to a particular concept node 404. Profile pages may be viewable by all or a selected subset of other users. As an example and not by way of limitation, a user node 402 may have a corresponding user-profile page in which the corresponding user may add content, make declarations, or otherwise express himself or herself. As another example and not by way of limitation, a concept node 404 may have a corresponding concept-profile page in which one or more users may add content, make declarations, or express themselves, particularly in relation to the concept corresponding to concept node 404.

In particular embodiments, a concept node 404 may represent a third-party webpage or resource hosted by a third-party system 370. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 330 to send to social-networking system 360 a message indicating the user's action. In response to the message, social-networking system 360 may create an edge (e.g., a check-in-type edge) between a user node 402 corresponding to the user and a concept node 404 corresponding to the third-party webpage or resource and store edge 406 in one or more data stores.

In particular embodiments, a pair of nodes in social graph 400 may be connected to each other by one or more edges 406. An edge 406 connecting a pair of nodes may represent a relationship between the pair of nodes. In particular embodiments, an edge 406 may include or represent one or more data objects or attributes corresponding to the relationship between a pair of nodes. As an example and not by way of limitation, a first user may indicate that a second user is a “friend” of the first user. In response to this indication, social-networking system 360 may send a “friend request” to the second user. If the second user confirms the “friend request,” social-networking system 360 may create an edge 406 connecting the first user's user node 402 to the second user's user node 402 in social graph 400 and store edge 406 as social-graph information in one or more of data stores 364. In the example of FIG. 4, social graph 400 includes an edge 406 indicating a friend relation between user nodes 402 of user “A” and user “B” and an edge indicating a friend relation between user nodes 402 of user “C” and user “B.” Although this disclosure describes or illustrates particular edges 406 with particular attributes connecting particular user nodes 402, this disclosure contemplates any suitable edges 406 with any suitable attributes connecting user nodes 402. As an example and not by way of limitation, an edge 406 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 400 by one or more edges 406. The degree of separation between two objects represented by two nodes, respectively, is a count of edges in a shortest path connecting the two nodes in the social graph 400. As an example and not by way of limitation, in the social graph 400, the user node 402 of user “C” is connected to the user node 402 of user “A” via multiple paths including, for example, a first path directly passing through the user node 402 of user “B,” a second path passing through the concept node 404 of company “Acme” and the user node 402 of user “D,” and a third path passing through the user nodes 402 and concept nodes 404 representing school “Stanford,” user “G,” company “Acme,” and user “D.” User “C” and user “A” have a degree of separation of two because the shortest path connecting their corresponding nodes (i.e., the first path) includes two edges 406.

In particular embodiments, an edge 406 between a user node 402 and a concept node 404 may represent a particular action or activity performed by a user associated with user node 402 toward a concept associated with a concept node 404. As an example and not by way of limitation, as illustrated in FIG. 4, a user may “like,” “attended,” “played,” “listened,” “cooked,” “worked at,” or “watched” a concept, each of which may correspond to an edge type or subtype. A concept-profile page corresponding to a concept node 404 may include, for example, a selectable “check in” icon (such as, for example, a clickable “check in” icon) or a selectable “add to favorites” icon. Similarly, after a user clicks these icons, social-networking system 360 may create a “favorite” edge or a “check in” edge in response to a user's action corresponding to a respective action. As another example and not by way of limitation, a user (user “C”) may listen to a particular song (“Imagine”) using a particular application (an online music application). In this case, social-networking system 360 may create a “listened” edge 406 and a “used” edge (as illustrated in FIG. 4) between user nodes 402 corresponding to the user and concept nodes 404 corresponding to the song and application to indicate that the user listened to the song and used the application. Moreover, social-networking system 360 may create a “played” edge 406 (as illustrated in FIG. 4) between concept nodes 404 corresponding to the song and the application to indicate that the particular song was played by the particular application. In this case, “played” edge 406 corresponds to an action performed by an external application on an external audio file (the song “Imagine”). Although this disclosure describes particular edges 406 with particular attributes connecting user nodes 402 and concept nodes 404, this disclosure contemplates any suitable edges 406 with any suitable attributes connecting user nodes 402 and concept nodes 404. Moreover, although this disclosure describes edges between a user node 402 and a concept node 404 representing a single relationship, this disclosure contemplates edges between a user node 402 and a concept node 404 representing one or more relationships. As an example and not by way of limitation, an edge 406 may represent both that a user likes and has used at a particular concept. Alternatively, another edge 406 may represent each type of relationship (or multiples of a single relationship) between a user node 402 and a concept node 404 (as illustrated in FIG. 4 between user node 402 for user “E” and concept node 404).

In particular embodiments, social-networking system 360 may create an edge 406 between a user node 402 and a concept node 404 in social graph 400. As an example and not by way of limitation, a user viewing a concept-profile page (such as, for example, by using a web browser or a special-purpose application hosted by the user's client system 330) may indicate that he or she likes the concept represented by the concept node 404 by clicking or selecting a “Like” icon, which may cause the user's client system 330 to send to social-networking system 360 a message indicating the user's liking of the concept associated with the concept-profile page. In response to the message, social-networking system 360 may create an edge 406 between user node 402 associated with the user and concept node 404, as illustrated by “like” edge 406 between the user and concept node 404. In particular embodiments, social-networking system 360 may store an edge 406 in one or more data stores. In particular embodiments, an edge 406 may be automatically formed by social-networking system 360 in response to a particular user action. As an example and not by way of limitation, if a first user uploads a picture, watches a movie, or listens to a song, an edge 406 may be formed between user node 402 corresponding to the first user and concept nodes 404 corresponding to those concepts. Although this disclosure describes forming particular edges 406 in particular manners, this disclosure contemplates forming any suitable edges 406 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social-networking system 360). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 360. In addition or as an alternative, the social action may be promoted outside or off of social-networking system 360, where appropriate. In particular embodiments, a page may be an on-line presence (such as a webpage or website within or outside of social-networking system 360) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 360. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. patent application publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, one or more ADOBE FLASH files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 360) or RSVP (e.g., through social-networking system 360) to an event associated with the advertisement. In addition or as an alternative, an advertisement may include social-networking-system content directed to the user. For example, an advertisement may display information about a friend of the user within social-networking system 360 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 360 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 360.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 360 to identify those users. In addition or as an alternative, social-networking system 360 may use user-profile information in social-networking system 360 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 360, off or outside of social-networking system 360, or on mobile computing devices of users. When on or within social-networking system 360, such targeting may be directed to users' news feeds, search results, e-mail or other in-boxes, or notifications channels or may appear in particular area of web pages of social-networking system 360, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 360, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 360 or explicit connections of a user to a node, object, entity, brand, or page on social-networking system 360. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals; light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/884,010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/624,088; U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574,614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096,184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

In particular embodiments, social-networking system 360 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 370 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 360 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 360 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 360 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 360 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 360 may calculate a coefficient based on a user's actions. Social-networking system 360 may monitor such actions on the online social network, on a third-party system 370, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 360 may calculate a coefficient based on the user's actions with particular types of content. The content may be associated with the online social network, a third-party system 370, or another suitable system. The content may include users, profile pages, posts, news stories, headlines, instant messages, chat room conversations, emails, advertisements, pictures, video, music, other suitable objects, or any combination thereof. Social-networking system 360 may analyze a user's actions to determine whether one or more of the actions indicate an affinity for subject matter, content, other users, and so forth. As an example and not by way of limitation, if a user frequently posts content related to “coffee” or variants thereof, social-networking system 360 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 360 may calculate a coefficient based on the type of relationship between particular objects. Referencing the social graph 400, social-networking system 360 may analyze the number and/or type of edges 406 connecting particular user nodes 402 and concept nodes 404 when calculating a coefficient. As an example and not by way of limitation, user nodes 402 that are connected by a spouse-type edge (representing that the two users are married) may be assigned a higher coefficient than a user nodes 402 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 360 may determine that the user has a higher coefficient with respect to the first photo than the second photo because having a tagged-in-type relationship with content may be assigned a higher weight and/or rating than having a like-type relationship with content. In particular embodiments, social-networking system 360 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 360 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 400. As an example and not by way of limitation, social-graph entities that are closer in the social graph 400 (i.e., fewer degrees of separation) may have a higher coefficient than entities that are further apart in the social graph 400.

In particular embodiments, social-networking system 360 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 330 of the user). A first user may be more interested in other users or concepts that are closer to the first user. As an example and not by way of limitation, if a user is one mile from an airport and two miles from a gas station, social-networking system 360 may determine that the user has a higher coefficient for the airport than the gas station based on the proximity of the airport to the user.

In particular embodiments, social-networking system 360 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 360 may provide information that is relevant to user's interests and current circumstances, increasing the likelihood that they will find such information of interest. In particular embodiments, social-networking system 360 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 360 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 360 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 370 (e.g., via an API or other communication channel), or from another suitable system. In response to the request, social-networking system 360 may calculate the coefficient (or access the coefficient information if it has previously been calculated and stored). In particular embodiments, social-networking system 360 may measure an affinity with respect to a particular process. Different processes (both internal and external to the online social network) may request a coefficient for a particular object or set of objects. Social-networking system 360 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 404 corresponding to a particular photo may have a privacy setting specifying that the photo may only be accessed by users tagged in the photo and their friends. In particular embodiments, privacy settings may allow users to opt in or opt out of having their actions logged by social-networking system 360 or shared with other systems (e.g., third-party system 370). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 370, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 362 may be authorization/privacy servers for enforcing privacy settings. In response to a request from a user (or other entity) for a particular object stored in a data store 364, social-networking system 360 may send a request to the data store 364 for the object. The request may identify the user associated with the request and may only be sent to the user (or a client system 330 of the user) if the authorization server determines that the user is authorized to access the object based on the privacy settings associated with the object. If the requesting user is not authorized to access the object, the authorization server may prevent the requested object from being retrieved from the data store 364, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

In particular embodiments, a blockchain is a data structure that may comprise an ordered, back-linked list of data records. The data records in a blockchain may be included in a plurality of blocks, each of which (except a genesis block) may comprise a reference to a preceding block. A blockchain may be used to enable various applications. For example, it may be used as a shared ledger of time-stamped transactions, which may facilitate efficient and secure recording of transactions among a plurality of parties.

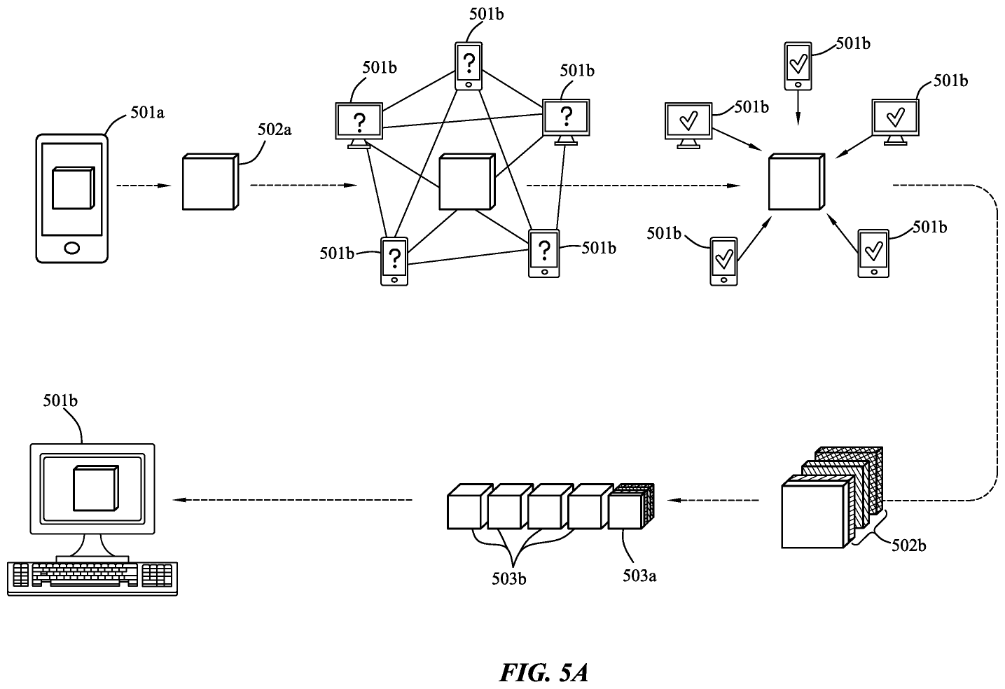

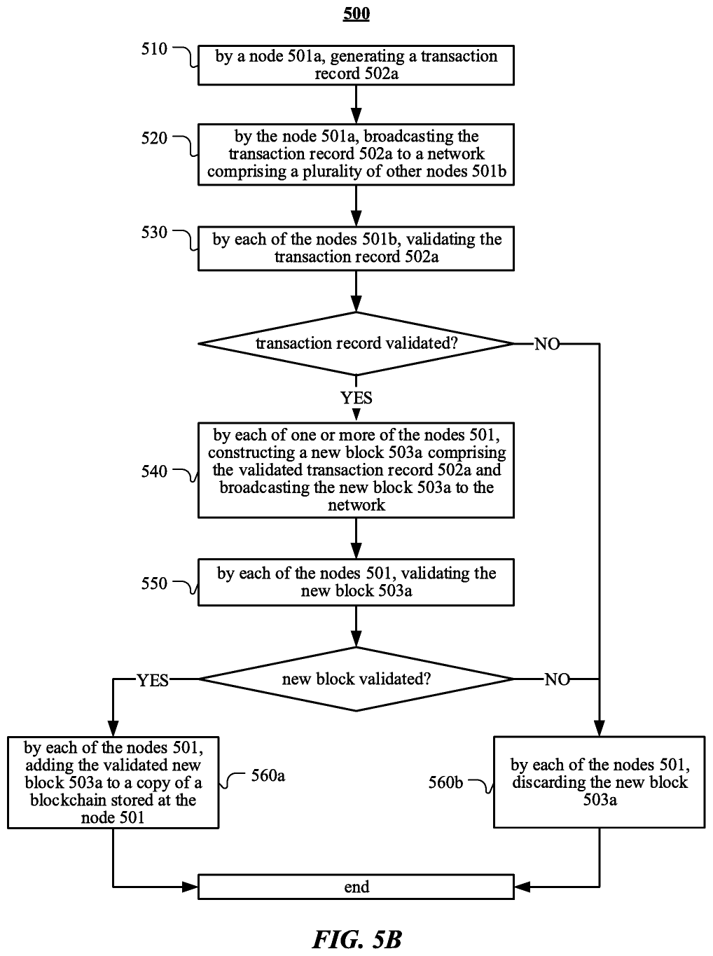

FIGS. 5A and 5B illustrate an example method 500 for recording a transaction in a blockchain. In particular embodiments, at step 510, a node 501a may generate a transaction record 502a. The node 501a may comprise a computing system (e.g., a data center, a computer server, a personal computer, a mobile device, a special-purpose circuit, a GPU) associated with a user. In particular embodiments, the node 501a may comprise one or more client applications configured to execute protocols for blockchain management. The functionalities of the one or more client applications may comprise storing one or more identifiers of an account associated with the user created using, for example, public-key cryptography, storing and updating a copy of a distributed blockchain, creating transactions, validating transactions, aggregating transactions to create blocks, validating blocks, discovering and maintaining connections to peer nodes, or performing one or more other suitable actions. The client applications may also support more than one accounts associated with the first user. In particular embodiments, each account may be associated with one or more private-public key pairs generated randomly or derived from a common seed. The private keys may be protected by one or more data-security methods. In particular embodiments, the transaction record 502a generated by the node 501a may comprise information about an input and an output associated with a corresponding transaction. The input may comprise one or more identifiers referencing one or more outputs of one or more previous transactions, information to establish control or ownership over the referenced output of the previous transaction, a digital signature created based on a private key associated with the account, a public key associated with the account and the private key, or other suitable information. The output may comprise a description of the subject of the transaction (e.g., an amount of assets, information, contract rights), a cryptographic puzzle that determines conditions required to take control or ownership of the output, information about or derived from a public key or address of an intended recipient account (the address may comprise a hash of the public key), or other suitable information.

At step 520, the node 501a may broadcast the transaction record 502a to a network comprising a plurality of other nodes 501b running client applications for executing the protocol for blockchain management. The network may further comprise one or more nodes 501 running one or more protocols incompatible with that run by the client applications associated with the node 501a, but connected to the network by one or more gateway routing servers. In particular embodiments, the network may be a non-hierarchical peer-to-peer (P2P) network. Alternatively, it may be a hierarchical network comprising one or more nodes having authority or administrative functionalities over other nodes. The architecture of the network may be structured on top of and based on the internet. Data transmitted within the network may be accessible to the public. Alternatively, one or more network connections associated with the network may be protected by encryption or authentication. In particular embodiments, when the network is a P2P network, a new node 501 may be added to the network by first establishing a network connection to at least one existing node 501. Once the new node 501 is connected to the network, it may then perform a “handshake” with the existing node 501 by exchanging information such as version information of the client applications or the protocol for blockchain management run by each node 501, a list of local services supported by each node 501, an IP address of each node 501, information about a copy of the blockchain stored at each node 501, or other suitable information. The existing node 501 may forward information about the new node 501 to one or more other existing nodes 501 and provide address information about one or more other existing nodes 501 to the new node 501, which would allow the new node 501 to discover and connect to additional nodes 501. Each node 501 may compare information about its own copy of the blockchain with such information received from a connected node 501. If a node 501 determines that a connected node 501 stores a fuller or newer copy of the blockchain (e.g., a blockchain with a greater height or number of blocks), it may request blockchain data from the connected node 501 and synchronize its copy of the blockchain to the fuller or newer copy.

At step 530, when a node 501b receives the transaction record 502a from the node 501a, it may independently validate the transaction record 502a. The node 501b may forward the transaction record 502a to one or more other nodes 501b if the transaction record 502a is validated. Otherwise, the node 501b may delete the transaction record 502a. This may ensure that only valid transaction records propagate across the network. The validation may comprise validating that the node 501a has satisfied the conditions for control or ownership over the output of a previous transaction that is referenced by the transaction record 502a. In other words, this may verify that the node 501a possesses the subject of the transaction 502a. In particular embodiments, the validation may be based on public-key cryptography. As an example and not by way of limitation, the validation may be based on a locking script and an unlocking script. The locking script may be included in the previous transaction referenced by the transaction record 502a and may specify one or more conditions that must be met for establishing control or ownership over the output of the referenced previous transaction. The unlocking script may be constructed by the node 501a based at least in part on the locking script, a public key associated with the node 501a, and a digital signature created based on a private key associated with the node 501a. Each node 501b may validate the transaction record 502a by executing the unlocking script and the locking script in sequence, which may return a Boolean value. The Boolean value True may correspond to successful validation. In particular alternative embodiments, the validation may be based on authentication of the transaction 502a and its corresponding account by a trusted authority. In particular embodiments, each node 501b receiving the transaction record 502a may further validate various other aspects of the transaction record 502a including, for example, the syntax and data structure of the transaction record 502a being correct, the size of the transaction record 502a being within a predetermined range, the value of the output of the transaction record 502a being within a predetermined range, the existence of a previous transaction referenced by the transaction record 502a in the blockchain or a pool of recently received transactions, current availability of an output of a previous transaction referenced by the transaction record 502a, the input of the transaction record 502a being sufficient to provide for the output of the transaction record 502a, the inclusion of any required transaction fees, or other suitable aspects of the transaction record 502a. The validation may require searching transactions in the blockchain for one or more previous transactions referenced by the transaction record 502a. If a node 501 stores a copy of the entire blockchain, it may perform the search locally. If a node 501 does not store a copy of the entire blockchain, it may request particular blocks of the blockchain or headers of particular blocks from one or more of its network connections. If a node 501b successfully validates the transaction record 502a, it may forward the transaction record 502a to one or more other nodes 501b in the network. In particular embodiments, validation of the transaction record by a subset of the nodes 501b may be sufficient to move on to step 540 and add a new block to the blockchain.

In addition to validating and forwarding a transaction record 502a, client applications associated with one or more of the nodes 501 may aggregate the transaction record 502a with a plurality of other transaction records 502b into a new block 503a for the blockchain. At step 540, a node 501 may construct a new block 503a by aggregating a plurality of received and validated transactions 502 that have not been included in a copy of the blockchain that the node 501 stores and broadcast the new block 503a to the network. An existing cycle of block construction may be terminated and a new cycle started either when the node 501 successfully constructs a new block or when the node 501 receives a valid new block from another node 501. The node 501 may construct the new block 503a such that it can be linked to the newest block in the copy of the blockchain stored by the node 501. In particular embodiments, the newly-created block 503a, like each of the other blocks 503b, may comprise a header and a plurality of transaction records 502. Each block 503 may further comprise one or more additional fields, such as a block-size field specifying the size of the block 503 and a transaction-counter field specifying the number of transactions included in the block 503.

In particular embodiments, the header of each block may comprise metadata including, for example, a reference to a block hash of a parent block, a summary of the transaction records included in the block, or other suitable data. The block hash of a particular block 503 may comprise a cryptographic hash of the header of the block 503 and may identify the block 503 uniquely and unambiguously. In particular embodiments, a parent block's block hash may be included in a header of its child block. The header of the child block may then be used to compute the child block's block hash, which may be included in a grandchild block's header. This way, the header of every block 503 may be dependent on the headers of all previous blocks 503 in the blockchain up to a genesis block (e.g., the very first block of a blockchain). It may thus be impossible to change the header of one block 503 in the blockchain without having to change the header of each of its descendants. In particular embodiments, the summary of the transaction records in the block 503a may comprise the root of a binary hash tree (or Merkle tree), which may be obtained by recursively hashing pairs of nodes in the binary hash tree. The leaf nodes of the binary hash tree may each comprise a cryptographic hash of one of the transaction records 502 included in the block 503a. A node 501 may efficiently prove the existence of a particular transaction record 502 in a block 503 by traversing the binary hash tree.

In particular embodiments, the protocol for blockchain management may structure a computationally resource-consuming challenge in the creation process for each new block 503. As an example and not by way of limitation, each node 501 may be required to include a solution satisfying a particular challenge (or a “proof-of-work”) in the header of a newly-created block 503 before any other node 501 would accept the block as valid. The protocol may also provide a reward to any node 501 that creates a new block 503 that is eventually included in the blockchain. One or more different nodes 501 may compete to solve the challenge quickly in order to reap the reward. The inclusion of such resource-consuming challenges may make it difficult for any node 501 or group of nodes 501 to attack the security of the blockchain, which may require fast creation of a number of compromised but formally valid blocks. In particular alternative embodiments, the protocol may allow one or more verified and trusted entities to aggregate transactions and construct blocks 503. The trusted entities may be related to a trusted authority associated with the network of nodes. A new block 503 created by a trusted entity may be automatically validated without proof of satisfaction of a particular challenge. After creating a valid new block 503, the node 501 may broadcast it to one or more other nodes 501 in the network.

At step 550, each node 501 receiving a new block 503a may validate the new block 503a. If the new block 503a is validated, the node 501 may add the new block 503a to its copy of the blockchain at step 560a. Otherwise, the node 501 may discard the new block 503a at step 560b. The blockchain may comprise one or more existing blocks 503b. A node 501 may validate various aspects of the new block 503a including, for example, the syntax and data structure of the block being correct, the size of the new block 503a being within an acceptable range, a timestamp included in the new block 503a being within an acceptable period, each transaction record 502 in the new block 503a being valid, a proof of satisfaction of any required challenge being present, or other suitable aspects. Once the new block 503a is validated, the receiving node 501 may identify a reference to the intended parent block 503b of the new block 503a. It may search through its copy of the blockchain to identify the referenced parent block 503b and link the new block to the identified parent block 503b. It may further broadcast the new block 503a to one or more connected nodes 501. In particular embodiments, no block 503b matching the reference to the intended parent of new block 503a may have been included in the blockchain stored by a receiving node 501. In this case, the node 501 may temporarily store the new block 503a in a pool of received blocks and add the new block 503a to the blockchain if a block 503b matching the reference is subsequently received. In particular embodiments, the block 503b referenced by the new block 503a as its parent may not be the newest block in the blockchain stored by the node 501. In this case, it may be determined that a “fork” event in the blockchain occurs because at least the referenced parent block 503b has more than one child blocks 503, thus forming at least two “branches.” The node 501 may select one of the “branches” as a main branch of the blockchain based on one or more rules specified in the protocol for blockchain management. As an example and not by way of limitation, the rules may require the node 501 to select the branch that represents the most proof-of-work or, often, the longest branch. A potential tie between two existing branches may be broken by one or more newly received blocks 503. Given that all nodes 501 obey the same rules for resolving fork events, the P2P network may eventually form a decentralized consensus treating a particular branch as the “true” copy of the blockchain. All other branches of a fork event may be removed by each of the nodes 501. In particular alternative embodiments, the protocol for blockchain management may allow for different branches to co-exist and propagate independently.

Particular embodiments may repeat one or more steps of the method of FIGS. 5A and 5B, where appropriate. Although this disclosure describes and illustrates particular steps of the method of FIGS. 5A and 5B as occurring in a particular order, this disclosure contemplates any suitable steps of the method of FIGS. 5A and 5B occurring in any suitable order. Moreover, although this disclosure describes and illustrates an example method for recording a transaction in a blockchain including the particular steps of the method of FIGS. 5A and 5B, this disclosure contemplates any suitable method for recording a transaction in a blockchain including any suitable steps, which may include all, some, or none of the steps of the method of FIGS. 5A and 5B, where appropriate. Furthermore, although this disclosure describes and illustrates particular components, devices, or systems carrying out particular steps of the method of FIGS. 5A and 5B, this disclosure contemplates any suitable combination of any suitable components, devices, or systems carrying out any suitable steps of the method of FIGS. 5A and 5B.

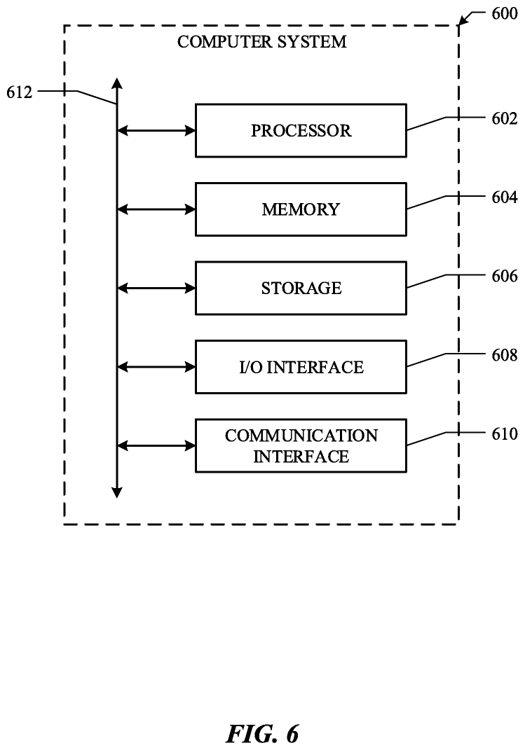

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising, by a computing device associated with a social-networking system:
by the computing device, receiving information associated with a project for creation of digital content from a content provider;
by the computing device, generating an object comprising the received information, wherein the object corresponds to a concept node on the social-networking system representing a virtual company associated with the content provider and the project, and is stored by the social-networking system;
by the computing device, generating a data item associated with a blockchain network separate from the social-networking system and broadcasting the data item into the blockchain network, wherein:
the data item is generated based on the information associated with the project that is comprised by the object;
a first type of the data item from a plurality of types of data items corresponds to a first type of token from a plurality of types of tokens recorded in a blockchain associated with the blockchain network, wherein the type of token represents equity in the virtual company;
the data item comprises instructions executable to implement one or more different functionalities for investing in the project for the creation of the digital content from a plurality functionalities associated with the data item according to a protocol associated with the blockchain network; and
the object comprises information about the digital content associated with the project, at least a portion of the digital content, and information associated with the data item associated with the blockchain network;
by the computing device, retrieving user profile information of a plurality of users of the social-networking system;
by the computing device, selecting one or more of the plurality of users having user-profile information corresponding to the information associated with the project;
by the computing device, sending, to one or more client devices respectively associated with the selected one or more users, an advertisement associated with the digital content;
by the computing device, receiving, from a first user from among the selected one or more users, a first request to invest in the project, wherein the first request comprises a first amount of fiat currency;
by the computing device, in response to receiving the first request to invest in the project, determining a first amount of cryptocurrency corresponding to the first amount of fiat currency;
by the computing device, receiving, from the first user, a second request to exchange the first amount of fiat currency for the first amount of cryptocurrency within the social-networking system, wherein an account of the first user on the social-networking system is linked to a first cryptocurrency wallet of the first user;
by the computing device, in response to receiving the second request to exchange the first amount of fiat currency for the first amount of cryptocurrency, uploading, to the blockchain network, a first transaction for transfer of the first amount of cryptocurrency from the first cryptocurrency wallet of the first user, wherein the first transaction references the data item and specifies a number of tokens of the type of token representing equity in the virtual company;
by the computing device, collecting information associated with the data item from the blockchain, wherein the information associated with the data item includes data of the first transaction, and wherein the information is accessible to the computing device based on one or more requisite cryptographic keys associated with the blockchain that are held by the social-networking system;
by the computing device, updating the object based on the collected information;
by the computing device, receiving created digital content associated with the project from the content provider; and
by the computing device, providing, to the first user, a link to a user interface associated with the virtual company for consuming the received digital content.

2. The method of claim 1, wherein the object further comprises:
information about one or more entities associated with the project; or
one or more content items created by one or more users of the social-networking system.

3. The method of claim 1, further comprising:
receiving, from a client device associated with a user, credentials associated with a payment for consuming the digital content; and
causing the payment to be collected based on the received credentials.

4. (canceled)

5. The method of claim 1, wherein the data item is executable to cause a sale of the tokens on the blockchain network.

6. The method of claim 1, wherein the causing the data item to be generated and deployed to the blockchain network comprises:
sending, to a third-party system interfacing with the blockchain network, instructions associated with the data item.

7. The method of claim 1, further comprising:
receiving, at the first cryptocurrency wallet of the first user linked with the account of the first user on the social-networking system and compatible with the protocol, the number of tokens of the first type associated with the data item, wherein the tokens are received from a second cryptocurrency wallet associated with the first user; and
sending, to a fiat currency account associated with the first user, a second amount of fiat currency, wherein the second amount of fiat currency is determined based on a value of the number of tokens.

8. One or more computer-readable non-transitory storage media embodying software that is operable when executed to:
receive information associated with a project for creation of digital content from a content provider;
generate an object comprising the received information, wherein the object corresponds to a concept node on a social-networking system representing a virtual company associated with the content provider and the project, and is stored by the social-networking system;
generate a data item associated with a blockchain network separate from the social-networking system and broadcast the data item into the blockchain network, wherein:
the data item is generated based on the information associated with the project that is comprised by the object;
a first type of the data item from a plurality of types of data items corresponds to a first type of token from a plurality of types of tokens recorded in a blockchain associated with the blockchain network, wherein the type of token represents equity in the virtual company;
the data item comprises instructions executable to implement one or more different functionalities for investing in the project for the creation of the digital content from a plurality functionalities associated with the data item according to a protocol associated with the blockchain network; and
the object comprises information about the digital content associated with the project, at least a portion of the digital content, and information associated with the data item associated with the blockchain network;
retrieve user profile information of a plurality of users of the social-networking system;
select one or more of the plurality of users having user-profile information corresponding to the information associated with the project;
send, to one or more client devices respectively associated with the selected one or more users, an advertisement associated with the digital content;
receive, from a first user from among the selected one or more users, a first request to invest in the project, wherein the first request comprises a first amount of fiat currency;
in response to receiving the first request to invest in the project, determine a first amount of cryptocurrency corresponding to the first amount of fiat currency;
receive, from the first user, a second request to exchange the first amount of fiat currency for the first amount of cryptocurrency within the social-networking system, wherein an account of the first user on the social-networking system is linked to a first cryptocurrency wallet of the first user;
in response to receiving the second request to exchange the first amount of fiat currency for the first amount of cryptocurrency, upload, to the blockchain network, a first transaction for transfer of the first amount of cryptocurrency from the first cryptocurrency wallet of the first user, wherein the first transaction references the data item and specifies a number of tokens of the type of token representing equity in the virtual company;
collect information associated with the data item from the blockchain, wherein the information associated with the data item includes data of the first transaction, and wherein the information is accessible to the computing device based on one or more requisite cryptographic keys associated with the blockchain that are held by the social-networking system;
update the object based on the collected information;
receive created digital content associated with the project from the content provider; and
provide, to the first user, a link to a user interface associated with the virtual company for consuming the received digital content.

9. The media of claim 8, wherein the object further comprises:
information about one or more entities associated with the project; or
one or more content items created by one or more users of the social-networking system.

10. The media of claim 8, wherein the software is further operable when executed to:
receive, from a client device associated with a user, credentials associated with a payment for consuming the digital content; and
cause the payment to be collected based on the received credentials.

11. (canceled)

12. The media of claim 8, wherein the data item is executable to cause a sale of the tokens on the blockchain network.

13. The media of claim 8, wherein the software operable when executed to cause the data item to be generated and deployed to the blockchain network comprises software that is operable when executed to:
send, to a third-party system interfacing with the blockchain network, instructions associated with the data item.

14. The media of claim 8, wherein the software is further operable when executed to:
receive, at the first cryptocurrency wallet of the first user linked with the account of the first user on the social-networking system and compatible with the protocol, the number of tokens of the first type associated with the data item, wherein the tokens are received from a second cryptocurrency wallet associated with the first user; and
send, to a fiat currency account associated with the first user, a second amount of fiat currency, wherein the second amount of fiat currency is determined based on a value of the number of tokens.

15. A system comprising:
one or more processors; and
one or more computer-readable non-transitory storage media coupled to one or more of the processors and comprising instructions operable when executed by one or more of the processors to cause the system to:
receive information associated with a project for creation of digital content from a content provider;
generate an object comprising the received information, wherein the object corresponds to a concept node on a social-networking system representing a virtual company associated with the content provider and the project, and is stored by the social-networking system;
generate a data item associated with a blockchain network separate from the social-networking system and broadcast the data item into the blockchain network, wherein:
the data item is generated based on the information associated with the project that is comprised by the object;
a first type of the data item from a plurality of types of data items corresponds to a first type of token from a plurality of types of tokens recorded in a blockchain associated with the blockchain network, wherein the type of token represents equity in the virtual company;
the data item comprises instructions executable to implement one or more different functionalities for investing in the project for the creation of the digital content from a plurality functionalities associated with the data item according to a protocol associated with the blockchain network; and
the object comprises information about the digital content associated with the project, at least a portion of the digital content, and information associated with the data item associated with the blockchain network;
retrieve user profile information of a plurality of users of the social-networking system;
select one or more of the plurality of users having user-profile information corresponding to the information associated with the project;
send, to one or more client devices respectively associated with the selected one or more users, an advertisement associated with the digital content;
receive, from a first user from among the selected one or more users, a first request to invest in the project, wherein the first request comprises a first amount of fiat currency;
in response to receiving the first request to invest in the project, determine a first amount of cryptocurrency corresponding to the first amount of fiat currency;
receive, from the first user, a second request to exchange the first amount of fiat currency for the first amount of cryptocurrency within the social-networking system, wherein an account of the first user on the social-networking system is linked to a first cryptocurrency wallet of the first user;
in response to receiving the second request to exchange the first amount of fiat currency for the first amount of cryptocurrency, upload, to the blockchain network, a first transaction for transfer of the first amount of cryptocurrency from the first cryptocurrency wallet of the first user, wherein the first transaction references the data item and specifies a number of tokens of the type of token representing equity in the virtual company;
collect information associated with the data item from the blockchain, wherein the information associated with the data item includes data of the first transaction, and wherein the information is accessible to the computing device based on one or more requisite cryptographic keys associated with the blockchain that are held by the social-networking system;
update the object based on the collected information;
receive created digital content associated with the project from the content provider; and
provide, to the first user, a link to a user interface associated with the virtual company for consuming the received digital content.

16. The system of claim 15, wherein the object comprises:
information about one or more entities associated with the project; or
one or more content items created by one or more users of the social-networking system.

17. The system of claim 15, wherein the processors are further operable when executing the instructions to:
receive, from a client device associated with a user, credentials associated with a payment for consuming the digital content; and
cause the payment to be collected based on the received credentials.

18. (canceled)

19. The system of claim 15, wherein the data item is executable to cause a sale of the tokens on the blockchain network.

20. The system of claim 15, wherein instructions operable when executed by one or more of the processors to cause the system to cause the data item to be generated and deployed to the blockchain network comprises instructions operable when executed by one or more of the processors to cause the system to:
send, to a third-party system interfacing with the blockchain network, instructions associated with the data item.
